(19) United States
(12) Patent Application Publication
(10) Pub. No.: US 2008/0313953 A1
(43) Pub. Date: Dec. 25, 2008

(54) No-touch block-rodenticide bait unit with protective end caps and packaging for the same

(76) Inventors: Matthew Pettigrew, York, PA (US); Peter Everett, Collinsville, CT (US); Steven Polisoto, Lancaster, PA (US)

Correspondence Address: JACOBSON HOLMAN PLLC, 400 SEVENTH STREET N.W., SUITE 600, WASHINGTON, DC, 20004, US

(21) Appl. No.: 12/155,665

(22) Filed: Jun. 6, 2008

Related U.S. Application Data
(60) Provisional application No. 60/924,950, filed on Jun. 6, 2007.

(51) Int. Cl. A01M 25/00; B65D 83/00; B65D 85/00

(52) U.S. Cl. 43/131; 206/471; 206/459.5; 206/469

(57) ABSTRACT

A poisoned bait unit having a bait portion and a gripping portion in which the gripping portion includes a pair of end caps respectively secured on two preferably opposing sides of the bait portion. The end caps are shaped and/or textured to ensure that the user can securely grasp and place the unit into position in even a tight or difficult-to-access space without ever touching the bait portion. Packaging for multiple bait units is also provided which not only allows for individual removal of each bait unit while the other units remain sealed, but prevents any contamination of the end caps of one unit by the bait portion of another so that the user is not exposed to physical contact with the bait portion at any time during dispensing and use of the units.

This application is entitled to and hereby claims the priority of co-pending U.S. Provisional application Ser. No. 60/924,950 filed Jun. 6, 2007.

### BACKGROUND OF THE INVENTION

1. Field of the Invention

The present invention is related to the field of pest extermination and, more particularly, to a poisoned bait delivery unit that protects the consumer by providing blocks of bait fitted with protective end caps that can be individually removed from a multiple-unit blister pack and that allow the user to handle and place each individual unit without touching the bait.

2. Description of the Related Art

Poisonous baits are well known for use in exterminating pests such as mice and rats. These baits must be placed in strategic locations in order to maximize the likelihood of contact by the target pest. Many of these locations are necessarily small as rodents are known to prefer tight spaces that provide them with a feeling of security. Placing the baits in such locations can be difficult and consumers attempting to do so often come into contact with the bait. Consumer studies have shown that such contact is viewed as highly undesirable, prompting users to seek out bait delivery systems that ensure a “no touch” or “hands-free” freedom from exposure to the bait.

### SUMMARY OF THE INVENTION

In view of the foregoing, one object of the present invention is to overcome the difficulties of placing bait delivery systems into tight locations without touching the bait by providing a bait unit having protective end caps that is configured to be easy to handle and place.

Another object of the present invention is to provide a poisoned bait unit that is ergonomically designed to facilitate the user's sure grip when handling and placing the unit to avoid the user's contact with the bait.

A further object of the present invention is to provide a poisoned bait unit configured to make the bait readily available to the pest while, at the same time, enabling the user to handle the unit without touching the bait.

Yet another object of the present invention is to provide a bait unit that is easy to use and economically disposable once the bait is gone or no longer being consumed.

A still further object of the present invention is to provide a multi-unit blister pack for sealingly packaging a plurality of bait units that allows the user to remove each bait unit individually without having any contact with the bait while the remaining units remain securely sealed.

In accordance with these and other objects, the present invention is directed to a poisoned bait unit having a bait portion and a gripping portion. The bait portion is preferably in the form of a block of rodenticide. The gripping portion includes a pair of end caps respectively secured on two preferably opposing sides of the bait portion. The end caps are shaped and/or textured to ensure that the user can securely grasp the unit between the thumb, as pressed against one end cap, and one or more fingers, as pressed against the other end cap. With this sure grip, the user can confidently reach out to place the bait unit into position in even a tight or difficult-to-access space without touching the bait.

The present invention is also directed to a multi-unit blister pack that is configured to sealingly package a plurality of bait units for individual removal. The blister pack allows the user to press out the desired number of bait units through pressure applied against the individual pre-formed blisters. Once removed, each bait unit can be grasped by the gripping portion so that the user can complete the entire process of dispensing and placing the bait unit in a desired location without touching the bait.

The foregoing objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a perspective view of a poisoned bait unit having a bait portion and a gripping portion in accordance with a first embodiment of the present invention.

FIG. 2A is a perspective view of a poisoned bait unit having a bait portion and a gripping portion according to a second embodiment of the present invention.

FIG. 2B is an exploded view of the bait unit of FIG. 2A.

FIG. 2C is a perspective view of another poisoned bait unit according to the second embodiment of the present invention.

FIG. 2D is an exploded view of the bait unit of FIG. 2C.

FIG. 3A is a perspective view of a poisoned bait unit having a bait portion and a gripping portion according to a third embodiment of the present invention.

FIG. 3B is an exploded view of the bait unit of FIG. 3A.

FIG. 4A is a perspective view of a poisoned bait unit having a bait portion and a gripping portion according to a fourth embodiment of the present invention.

FIG. 4B is an exploded view of the bait unit of FIG. 4A.

FIG. 5 is a front perspective view of an inner blister pack with nine bait units sealed therein according to the present invention.

FIG. 6 is an exploded perspective view of a first packaging embodiment in which the sealed inner blister pack of FIG. 5 is to be enclosed within an outer blister and card in accordance with the present invention.

FIG. 7 is a perspective assembled view of the inner and outer blister packs and card of FIG. 6.

FIG. 8 depicts a second packaging embodiment in accordance with the present invention, in which a die-cut frame is perforated and folded to receive the inner blister pack and nine bait units of FIG. 5.

FIG. 9 is a front perspective view of the die-cut frame of FIG. 8 assembled with the inner blister pack and nine bait units packaged therein.

FIG. 10 is a rear perspective view of the assembled die-cut frame of FIG. 9.

FIG. 11 is a rear perspective view of the die cut frame of FIG. 10 in the process of being opened by the user.

FIG. 12 depicts a third packaging embodiment according to the present invention in which an outer blister is sealed to a paperboard backing having graphics thereon to demonstrate a user holding the bait unit between the thumb and forefinger.

FIG. 13 shows the back of the package of FIG. 12 and includes graphics thereon to demonstrate a user removing a bait unit from one of the recesses by pushing it through a respective one of the closed openings which are defined by perforations.

FIG. 14 is a side view of the third packaging embodiment of FIG. 12 with bait units as shown in FIGS. 2C and 2D.

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

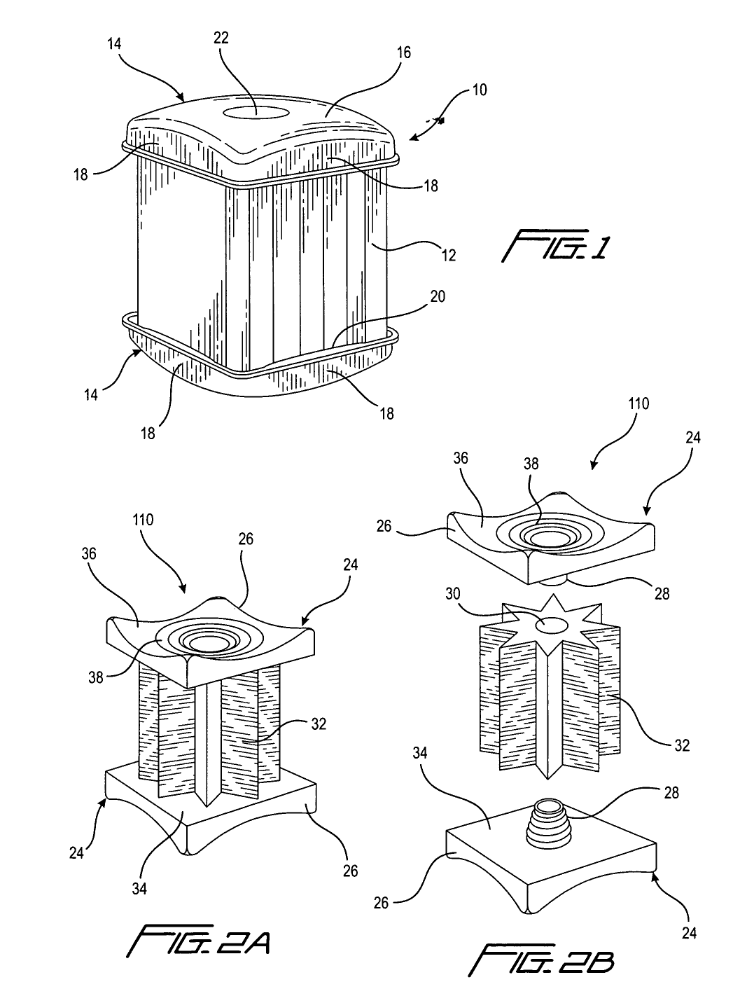

As shown in FIG. 1, a first embodiment of the present invention includes a poisoned bait unit, generally designated by the reference numeral 10, having a portion of bait such as a bait block 12 and a gripping portion in the form of a pair of end caps generally designated by the reference numeral 14. The bait block 12 contains a rodenticide, the composition of which does not form a part of this invention; any rodenticide composition that can be formed into blocks for the bait unit as disclosed herein is suitable for the present invention.

The end caps 14 are secured on two sides of the bait block 12. In the preferred embodiments disclosed herein, the end caps 14 are secured on opposing sides of the block so as to be generally parallel with one another. However, it is possible that the bait portion could be shaped irregularly such that one of the end caps would be angled relative to the other.

In the embodiment of FIG. 1, each end cap 14 includes an end piece 16 and four side edges 18 oriented so as to be generally perpendicular to the end piece 16. Upper and lower sides of the bait block 12 are respectively secured with a friction fit within the cup area 20 defined by the end piece 16 and the four side edges 18 of each of the end caps 14.

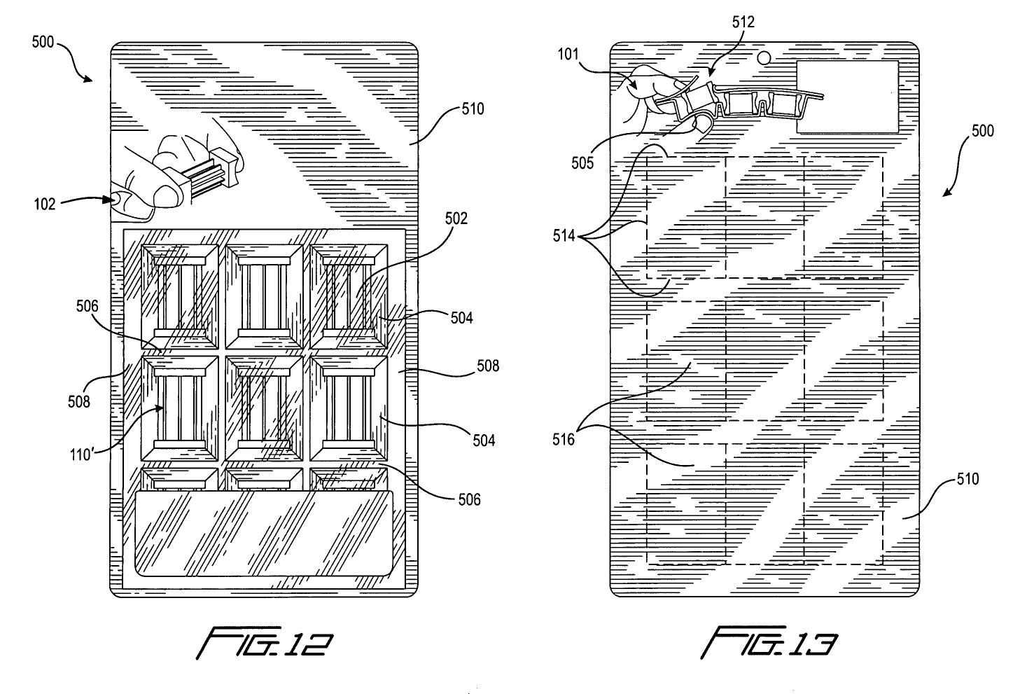

In the embodiment of FIG. 1, the end pieces 16 have a domed configuration for strength, with a contoured outer surface to provide the user's fingers with a non-slip gripping area 22. By grasping the bait unit 10 with the thumb and forefinger, for example, on the lower and upper end pieces, respectively, the user can securely hold and place the bait unit in a desired location without any risk of touching the bait block (see FIG. 12).

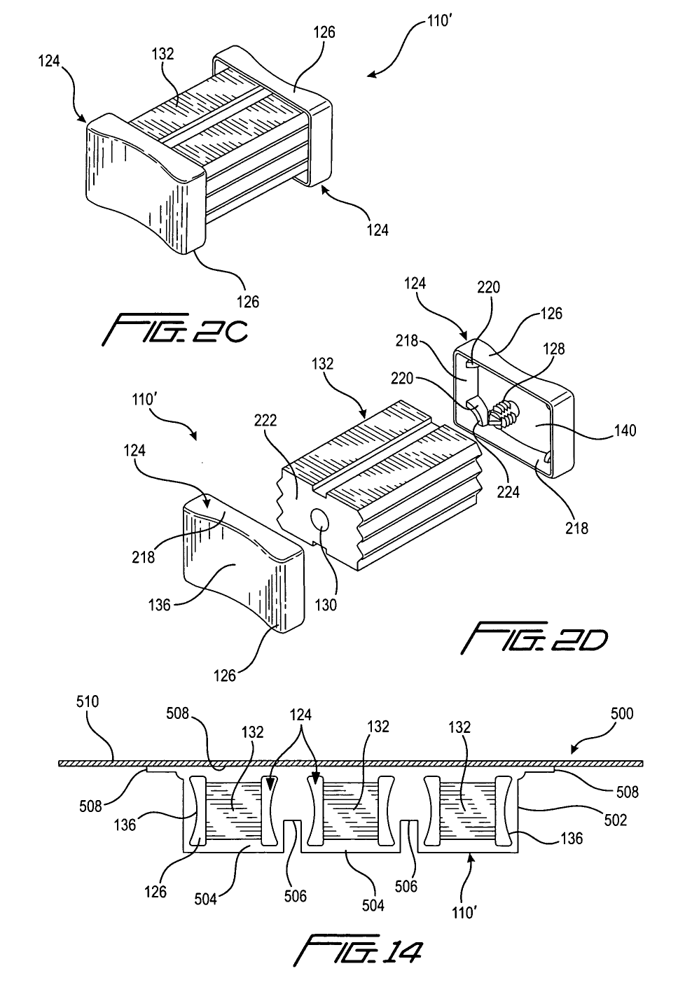

A second embodiment of a bait unit in accordance with the present invention, generally designated by reference numerals 110 and 110′, is illustrated in FIGS. 2A and 2B and in FIGS. 2C and 2D, respectively. As seen in the exploded views of FIGS. 2B and 2D, the end caps, generally designated by the reference numerals 24, 124 have end pieces 26, 126 that are injection molded to include push-fit bosses 28, 128 that are inserted into the sides of the bait block 32, 132, preferably into corresponding complementary bores 30, 130. The push-fit bosses 28, 128 formed by injection molding and bores 30, 130 maximize the user's grip without creating stress on the unit.

In FIGS. 2A and 2B, the bait block interface surface 34 of the end pieces 26 is substantially planar, while the opposing outer surfaces 36 are generally concave. The concave outer surfaces 36 can be formed to include texture elements 38, such as grip, graphic and/or branding details, that can further facilitate the user's grip and also provide trademark or trade dress information, as desired.

In FIGS. 2C and 2D, the end pieces 126 have side edges 218 oriented so as to be generally perpendicular to the end piece 126, as in FIG. 1. Braces 220 on the underside 140 of the end caps 124 define an insert position for the bait block 132. More particularly, the bosses 128 are inserted into the bores 130 of the bait block 132 until the end surfaces 222 of the bait blocks 132 rest on the faces 224 of the braces 220. The outer surfaces 136 of the end pieces 126 are generally concave to facilitate the user's grip.

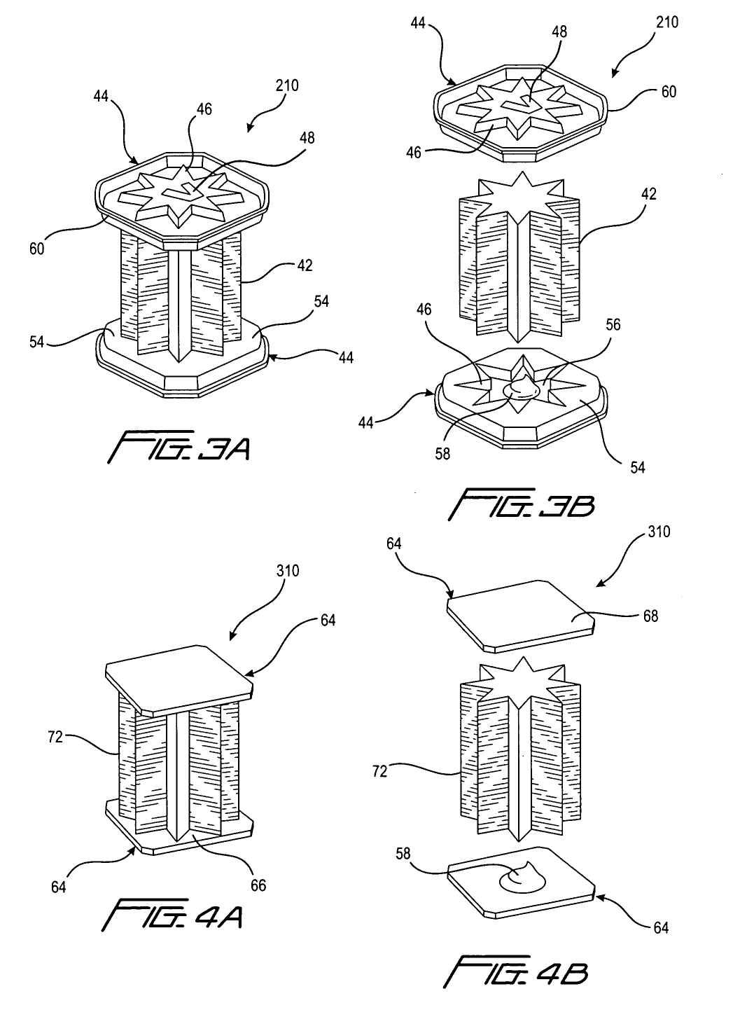

A third embodiment of a bait unit in accordance with the present invention, generally designated by the reference numeral 210, is illustrated in FIGS. 3A and 3B. As seen in the exploded view of FIG. 3B, the end caps, generally designated by the reference numeral 44, are thermoformed of thin gauge material and can be made to include embossed texturing 46 and/or branding 48 on their outer surface. The bait block interface surface 54 of the end caps 44 is formed to have a recessed area 56 that is shaped to correspond with the ends of the bait block 42. Hot glue 58 or other adhesive is applied to the recessed area 56 with the bait block ends then being pressed therein. The opposing outer surfaces 60 of the end caps 44 have a raised area that corresponds in shape with the opposing recessed area 56 and provides the texturing 46 and/or branding 48 configuration. The texturing and branding shown in the figures is representative only and is not meant to be limiting as to the patterning or specific brand content thereof.

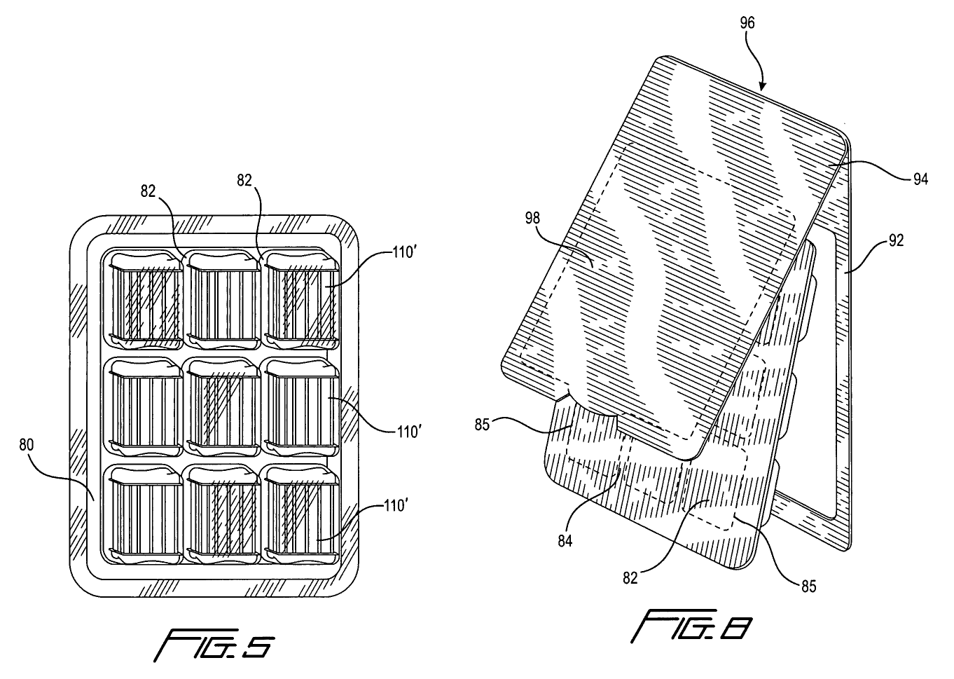

A fourth embodiment of a bait unit in accordance with the present invention, generally designated by the reference numeral 310, is illustrated in FIGS. 4A and 4B. As seen in the exploded view of FIG. 4B, the end caps, generally designated by the reference numeral 64, can be made of paperboard or other low-cost printable material. The bait block interface surface 66 as well as the opposing outer surface 68 are substantially planar, with the bait block 72 being secured to the end caps by adhesive 58, such as hot-melt glue, or by ultrasonic welding. Any other fastening material or method may be used as dependent upon the paperboard coatings and the properties of the bait block 72.

As shown in the four embodiments of FIG. 1 through FIG. 4B, the bait blocks 12, 32, 42, 72 may be variously shaped. The shapes often include multiple edges as rodents are known to find such surfaces desirable for chewing. However, any shape may be used, including a generally rectangular shape as shown by bait blocks 82 of FIG. 13, as would be known in the art.

The end caps 14, 44 may be tailored to the specific bait block shape, as in the embodiments of FIG. 1 and FIGS. 3A-3B, or may be virtually independent of the bait block shape, as representatively depicted by the end caps 24, 64, 124 of FIGS. 2A-2D, 4A-4B and 13. In any case, and however they are attached to the bait block, the end caps 14, 24, 44, 64, 124 serve as the gripping portion to allow the user to firmly grip the bait block 12, 32, 42, 72, 132 without touching it. The outer surface of the end caps can also be used to display branding and graphic features as desired.

The present invention is also directed to a manner of packaging any of the above described bait units that not only showcases the enhanced appearance of the units, but also further protects the user from contact with the poisoned bait. As representatively shown in FIG. 5, the bait units 110 are fitted within an inner blister 80 having a plurality of pockets 82 for individually securing a corresponding plurality of bait units 110. Once the units are in place, the pockets 82 are sealed with foil as is known in the blister packaging industry to form inner blister pack 84.

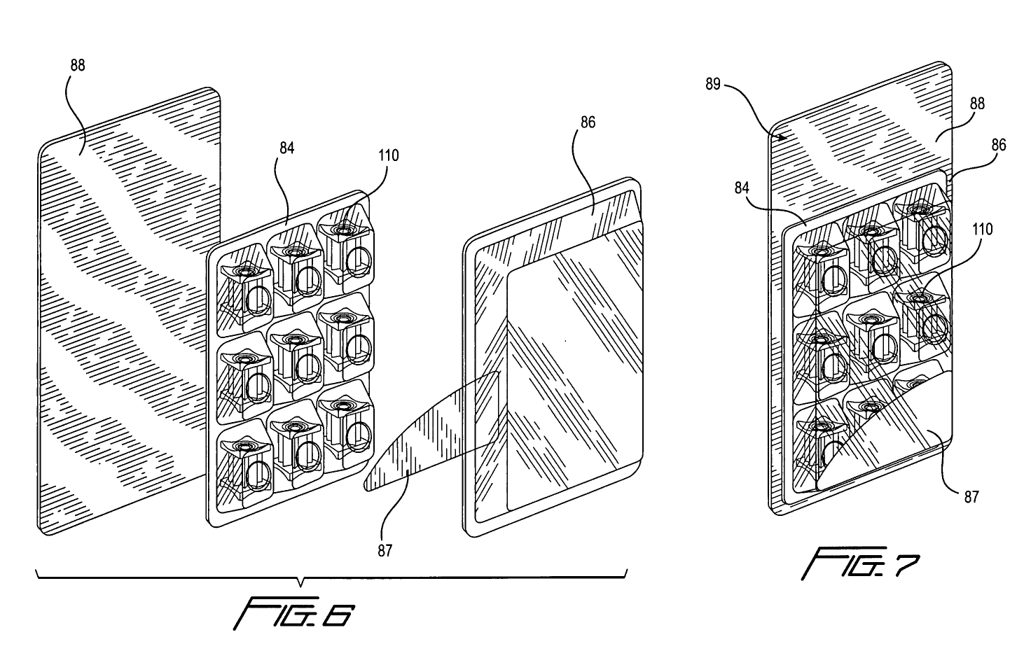

FIGS. 6 and 7 illustrate a first embodiment of a final packaging configuration in accordance with the present invention. The inner blister pack 84 containing, for example, nine bait units 110, is enclosed between an external blister 86 with information card 87, and a paperboard card 88 to form an outer blister pack generally designated by the reference numeral 89. The paperboard card 88 has a heat sealed coating on the front side 90 to enable it to be sealed against the external blister 86 with the blister pack 84 inside, as shown in the assembled view of FIG. 7. The outer blister pack 89 protects the product from shipping and in-store damage. The outer blister pack 89 also provides another layer of protection from tampering with or breakage of the bait units.

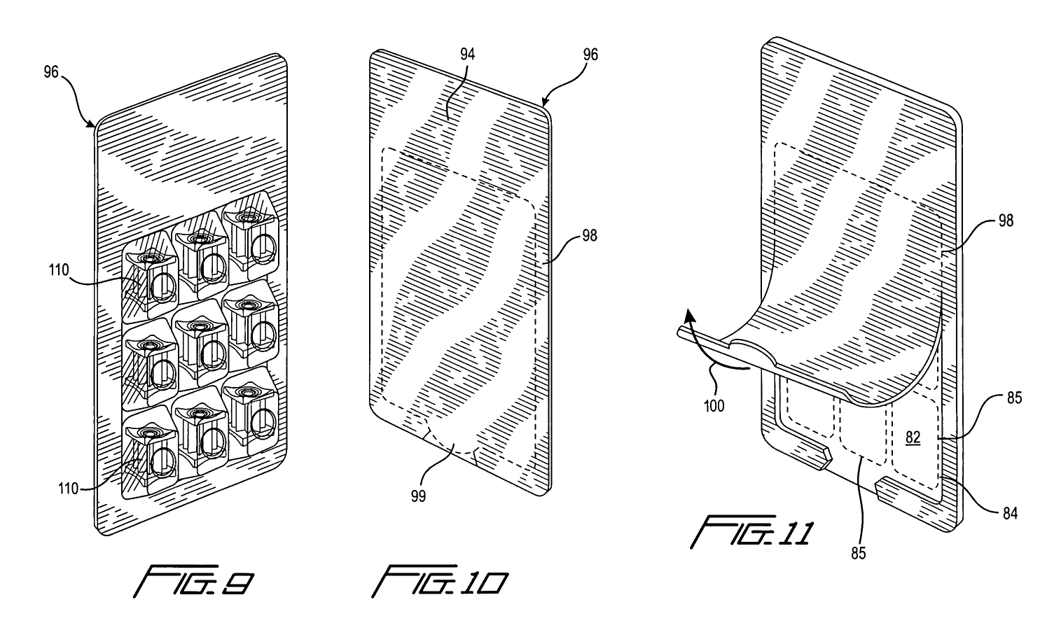

FIGS. 8 and 9 illustrate a second embodiment of a final packaging configuration in accordance with the present invention. The blister pack 84 is inserted between the front panel 92 and the back panel 94 of a folded die-cut frame, generally designated by the reference numeral 96, as shown in FIG. 8. The interfacing surfaces of the front and back panels 92, 94 are then sealed together to enclose the blister pack 84, as shown in FIG. 9.

As can be seen in FIGS. 8 and 10, the back panel 94 is provided with a perforation 98 and a gripping tab 99. By grasping the gripping tab 99, the user can peel open the back panel 94 upward as shown by the arrow 100 in FIG. 11. This will expose the back of the blister pack 84 and the perforations 85 outlining each of the bait unit pockets 82. Once exposed, the bait units 110 can be removed one at a time while the remainder of the units remain in their securely sealed condition.

A third packaging embodiment generally designated by reference numeral 500 is shown in FIG. 12-14 with bait units 110′ as in FIGS. 2C and 2D. As can be seen in the side view provided in FIG. 14, the package 500 holds a plurality of bait units 110′ having generally rectangular bait blocks 132 and end caps 124 with a concave outer surface 136.

As shown in FIG. 14, the bait units 110′ are secured within an outer blister 502 formed to have a plurality of recesses 504 that respectively receive a corresponding plurality of bait units 110′. The recesses 504 are separated from one another by channels 506 that keep the bait units apart from one another. The upper edge 508 of the outer blister 502 is sealed to a paperboard-type backing 510 that remains structurally stable even when perforated and which can be printed with desired product information as shown in FIGS. 12 and 13.

With reference to FIG. 13, the backing is provided with a plurality of closed openings generally designated by reference numeral 512 which are defined by partial perforations or lines of weakening 514 that define rectangular covers 516 corresponding in shape and position with the underlying bait units 110′. Hence, as with the previous embodiments, each bait unit 110′ can be individually removed by pressing against the bait unit through the front 505 of the blister recess 504, thereby opening the respective cover 516 on the back of the package by tearing its defining perforation 514. Meanwhile, the remainder of the bait units remain in the package 500 enclosed between the blister 502 and the remainder of the backing 510.

In sum, a user obtaining the bait units as designed and as packaged according to the present invention can remove the desired number of bait units by pressing them out through their respective perforated backing covers 516 one at a time from the package 500 as depicted at 101 in FIG. 13. Once the bait units are removed, the concave outer surfaces of the end caps 124 provide the user with a secure and balanced hold on each bait unit as depicted at 102 in FIG. 12 (while noting that the end caps in FIG. 12 are not depicted with concave outer surfaces). This sure grip enables the user to confidently reach out and place the unit in difficult to reach and/or tight spaces without risk of accidental physical contact with the bait block. Once the bait is gone or consumption thereof has stopped, the user can simply and safely dispose of the end caps or any remaining bait by handling only the end caps. Hence, physical contact with the bait block itself is readily avoided at all times from purchase to disposal.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. For example, the bait dispenser according to the present invention may be seen to be applicable to the dispensing of insect bait or any other bait offering in which user separation from the bait is desired. Therefore, it is not desired to limit the invention to the specific examples disclosed or the exact construction and operation shown and described. Rather, all suitable modifications and equivalents may be resorted to, falling within the scope of the invention.

What is claimed is:

1. A bait unit comprising a solid bait and a gripping element attached to said solid bait and configured to enable a user to handle the bait unit without physically contacting the solid bait, said gripping element remaining attached to said solid bait when said bait unit is in use.

2. The bait unit as set forth in claim 1, wherein said gripping element includes two end caps positioned on opposite sides of said solid bait.

3. The bait unit as set forth in claim 2, wherein each end cap includes an end piece and side edges that define a cup area, said solid bait being received in said cup area.

4. The bait unit as set forth in claim 2, wherein said end caps are injection molded to include an end piece and a push-fit boss projecting from a first side of said end piece and configured to be inserted into a respective end of said solid bait.

5. The bait unit as set forth in claim 4, wherein said end piece is substantially planar on said first side, a second side opposite said first side being generally concave to facilitate the user's grip.

6. The bait unit as set forth in claim 4, wherein a second side opposite said first side includes texture elements to facilitate the user's grip.

7. A combination comprising a package and a plurality of bait units, each bait unit including a solid bait and a gripping element configured to enable a user to handle said bait unit without physically contacting said solid bait, said gripping element remaining with said solid bait when said bait unit is in use, said package including a blister having a plurality of pockets or recesses for individually receiving said plurality of bait units, respectively.

8. The combination as set forth in claim 7, wherein said blister is sealed with foil to form a blister pack which is further enclosed within an outer package configured to enclose said blister pack and bearing textual information pertaining to the bait units.

9. The combination as set forth in claim 8, wherein said outer package is an external blister and includes an information member bearing said textual information.

10. The combination as set forth in claim 8, wherein said outer package is a folded die-cut frame having a front panel and a back panel, said back panel having a perforation and a gripping tab by which the user can peel back the back panel to expose said blister pack.

11. The combination as set forth in claim 7, wherein the blister is adhered to a paperboard backing to enclose the bait units, said backing including a plurality of closed opening defined by perforations which outline one of said bait unit recesses to facilitate individual removal of the bait units while a remainder of said bait units remain sealed in said package.

12. The combination as set forth in claim 7, wherein said gripping element includes two end caps attached to opposite sides of said solid bait.

13. The combination as set forth in claim 12, wherein each end cap includes an end piece and side edges that define a cup area, said solid bait being received in said cup area.

14. The combination as set forth in claim 12, wherein said end caps include an end piece with a push-fit boss projecting from a first side of said end piece and configured to be inserted into a respective end of said solid bait.

15. The combination as set forth in claim 14, wherein said end piece is substantially planar on said first side, a second side opposite said first side being generally concave to facilitate the user's grip.

16. The combination as set forth in claim 14, wherein a second side opposite said first side includes texture elements to facilitate the user's grip.

17. A bait unit comprising a bait block having a generally symmetrical shape with two opposing ends, and respective gripping elements attached to each of said ends that enable a user to grasp and place the bait block in a desired location without physically contacting said block by pressing the thumb and forefinger of one hand against the opposing gripping elements with the bait block held therebetween.

18. The bait unit as set forth in claim 17, wherein said gripping elements include two end caps, each end cap having a first side secured to one of the bait block ends and a second side opposite the first side with a concave outer surface to enhance the user's grip.

19. The bait unit as set forth in claim 18, wherein said bait unit is packaged with a plurality of bait units in a sealed package from which each bait unit can be individually removed while a remainder of the bait units remain in a sealed condition within said package.

20. The bait unit as set forth in claim 19, wherein said package includes a blister that separates the bait units from each other and a paperboard backing that covers a back of said blister to seal the package.
